(19) United States
(12) Patent Application Publication
(10) Pub. No.: US 2026/0219429 A1
(43) Pub. Date: Jul. 30, 2026

(54) OPTICAL FILTERS

(71) Applicant: Mustard Seed Design Co., Ltd., Taipei City (TW)

(72) Inventor: Chan-Jung HSU, Taipei City (TW)

(73) Assignee: Mustard Seed Design Co., Ltd., Taipei City (TW)

(21) Appl. No.: 19/456,843

(22) Filed: Jan. 22, 2026

Related U.S. Application Data
(63) Continuation-in-part of application No. 19/222,339, filed on May 29, 2025.

(30) Foreign Application Priority Data
Jan. 23, 2025 (TW) 114103074

(51) Int. Cl. G02B 5/22

(52) U.S. Cl. CPC G02B 5/223

(57) ABSTRACT

An optical filter is disclosed for mitigating blue light hazards while preserving display image quality. The filter incorporates a multi-dye light absorption layer deposited on a transparent substrate. The absorption layer comprises a first light-absorbing dye configured to attenuate blue light within the 435 nm to 460 nm spectral range, and a second light-absorbing dye designed to absorb orange-red light between 580 nm and 640 nm with a minimum average absorption rate of 15%. The present disclosure facilitates direct color temperature compensation through selective orange-red wavelength absorption, enabling the filter film to simultaneously deliver effective blue light hazard mitigation and optimal display performance. Moreover, it provides universal compatibility across LED and OLED backlight technologies, offering versatile solutions for diverse display disclosures.

### CROSS-REFERENCE TO RELATED APPLICATIONS

This application claims priority to Taiwan Patent Application No. 114103074, filed on Jan. 23, 2025, the entire disclosure of which is hereby incorporated by reference herein. This application also is a continuation-in-part of U.S. nonprovisional application Ser. No. 19/222,339.

### FIELD OF THE DISCLOSURE

The present disclosure relates to blue light filtering technology, and particularly to an optical filter having high blue light hazard blocking effect while maintaining display performance.

### BACKGROUND

Reference is made to U.S. Ser. No. 19/222,339 patent application, which discloses absorption in the orange-red light wavelength range of 580 nm to 620 nm with a center wavelength between 590 nm and 610 nm to directly compensate color temperature, thereby achieving the effect of improving blue light hazard blocking while maintaining screen display without color deviation. The inventor of that application is the same as the present case.

With reference to FIG. 1, which shows a schematic diagram of light source waveforms for LCD and OLED backlight modules. As can be seen from FIG. 1, the orange-red light source waveform 10 of LCD backlight modules has a peak around 600 nm (higher transmittance), while the orange-red light source waveform 12 of OLED backlight modules has higher transmittance around 620 nm. Therefore, the inventor decided to conduct experiments based on the aforementioned application to see if it is possible to develop an anti-blue light optical filter that can be universally applied to different backlight module applications while maintaining good display effects.

### SUMMARY

One aspect of the present disclosure is to provide an optical filter that can be universally applied to different backlight modules, having high blue light hazard blocking effect while maintaining display performance.

According to one embodiment, the optical filter comprises a light absorption layer formed on a transparent substrate by mixing multiple dyes, the light absorption layer including a first light-absorbing dye and a second light-absorbing dye. The first light-absorbing dye absorbs blue light between 435 nm and 460 nm. The second light-absorbing dye absorbs orange-red light between 580 nm and 640 nm with an average absorption rate greater than or equal to 15%.

According to another embodiment, the first light-absorbing dye absorbs blue light with an absorption rate greater than or equal to 50% in the wavelength range of 435 nm to 440 nm, or absorbs 30% to 50% in the range of 435 nm to 440 nm, and absorbs greater than 10% of blue light in the wavelength range of 450 nm to 460 nm.

Therefore, the present disclosure directly compensates color temperature by absorbing in the orange-red light wavelength range of 580 nm to 640 nm, controlling the absorption rate in this wavelength range to be greater than or equal to 15%, allowing the optical filter to not only have the dual effects of high blue light hazard blocking and maintaining display performance, but also to be universally applicable to LCD and OLED backlight module applications.

### BRIEF DESCRIPTION OF THE DRAWINGS

FIG. 1 is a schematic diagram of light source waveforms for LCD and OLED backlight modules.

FIG. 2 is an exemplary diagram illustrating a spectrum in accordance with an embodiment of the present disclosure.

FIG. 3 is an exemplary diagram illustrating a spectrum in accordance with yet another embodiment of the present disclosure.

FIG. 4 is an exemplary diagram illustrating a spectrum in accordance with still another embodiment of the present disclosure.

FIG. 5 is an exemplary diagram illustrating a spectrum in accordance with other embodiment of the present disclosure.

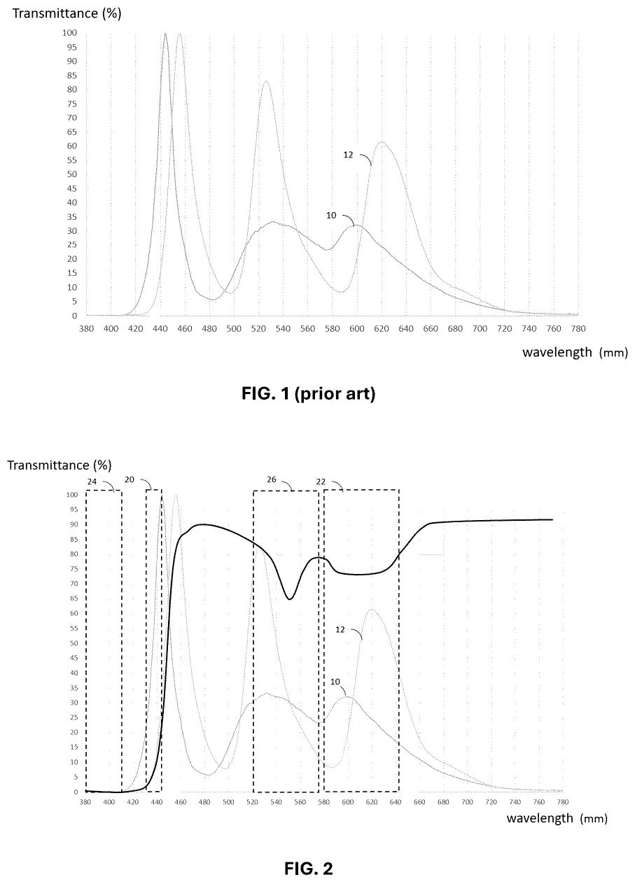

### DETAILED DESCRIPTIONS

With reference to FIG. 2, a spectral diagram illustrating one embodiment of the optical filter according to the present disclosure is shown. This embodiment comprises a light absorption layer formed by coating a transparent substrate with multiple dyes in combination, wherein the light absorption layer incorporates a first light-absorbing dye and a second light-absorbing dye as primary components.

For clarity of explanation, the spectral representations in the accompanying figures utilize light transmittance measurements. When incident light from a source traverses the transparent substrate, the relationship between absorption and transmittance is inversely proportional, for instance, a 60% absorption rate corresponds to 40% transmittance. In this embodiment, the first light-absorbing dye exhibits absorption rates of 80% to 90% for blue light within wavelength range 20 (435 nm to 440 nm), corresponding to transmittance values of 20% to 10%. The second light-absorbing dye targets orange-red light within wavelength range 22 (580 nm to 640 nm). The incorporation of orange-red light-absorbing dyes introduces controlled color temperature deviation. In this configuration, color temperature shift from the original light source is constrained within 500K. For example, when 6500K color temperature light passes through the filter system, the first light-absorbing dye initially reduces the color temperature to approximately 5000K through blue light attenuation. The second light-absorbing dye subsequently provides compensatory correction by selectively absorbing orange-red wavelengths, restoring the color temperature to approximately 6000K to 6500K.

As shown in FIG. 2, the second light-absorbing dye exhibits absorption characteristics within orange-red wavelength range 22 (580 nm-640 nm) with average absorption rates exceeding 25%, equivalent to 75% transmittance. This absorption profile strategically encompasses both the 600 nm emission peak characteristic of LCD backlight systems (waveform 10) and the 620 nm emission peak typical of OLED backlight systems (waveform 12), enabling the optical filter to deliver superior display performance across both LCD and OLED applications.

Nevertheless, achieving optimal display quality requires understanding that minimizing color temperature deviation alone does not guarantee elimination of perceptible color discrepancies. Although the second light-absorbing dye provides effective color temperature compensation, human visual perception exhibits wavelength-dependent sensitivity variations. Therefore, identical color temperatures may still produce distinguishable visual appearances due to underlying spectral distribution differences, a phenomenon characterized as color tolerance or metameric color difference.

Experimental results conducted by the inventor revealed that despite orange-red light absorption by the second light-absorbing dye, the compensated white color at 6000K-6500K color temperature exhibited perceptible color deviation when compared to the original spectrum. To address this issue, the light absorption layer incorporates a third light-absorbing dye targeting the green light wavelength range 26 from 520 nm to 580 nm, with maximum absorption peaks ranging between 10% and 40%.

The visible light spectrum for human vision typically spans 380 nm to 780 nm, wherein the violet-blue region (380 nm to 410 nm) possesses the highest energy content, followed by the blue light region. While blue light wavelengths from 400 nm to 500 nm are known to cause photochemical damage to human eyes, the violet-blue light spectrum from 380 nm to 410 nm presents particular concern due to its proximity to ultraviolet A radiation and correspondingly higher energy levels. This high-energy radiation demonstrates significant dermal penetration capability, reaching the dermis layer where it degrades collagen and elastic fibers while generating harmful free radicals. These effects accelerate skin aging processes and stimulate melanin production. Consequently, the first light-absorbing dye is designed to absorb not only blue light in the 435 nm to 440 nm range but also 90% to 100% (corresponding to 10% to 0% transmittance) of violet-blue light in the wavelength range 24 from 380 nm to 410 nm.

The specified absorption wavelength ranges for the aforementioned light-absorbing dyes represent optimal absorption regions where each material demonstrates peak performance characteristics. It should be understood that spectral absorption extends beyond these primary ranges, creating overlapping absorption effects across the broader spectrum. The stated absorption rates may be achieved through single-component materials or through synergistic combinations of multiple light-absorbing compounds. For instance, the first light-absorbing dye targeting blue light wavelengths may comprise a blend of two or more distinct light-absorbing particle materials to achieve the desired spectral response.

Given the distinct spectral characteristics of different display technologies, wherein OLED backlight sources exhibit blue light emission peaks at approximately 455 nm compared to LCD backlight sources which peak near 444 nm, the absorption profile of the first light-absorbing dye can be strategically optimized. Specifically, the absorption rate within the 435 nm to 440 nm wavelength range may be reduced while simultaneously enhancing blue light absorption around 455 nm, thereby improving the filter's effectiveness against OLED-specific blue light emissions. This optimization allows the first light-absorbing dye to be configured with absorption rates below 50% (typically 30% to 50%) in the 435 nm-440 nm range, while maintaining absorption rates exceeding 10% within any wavelength band between 450 nm-460 nm.

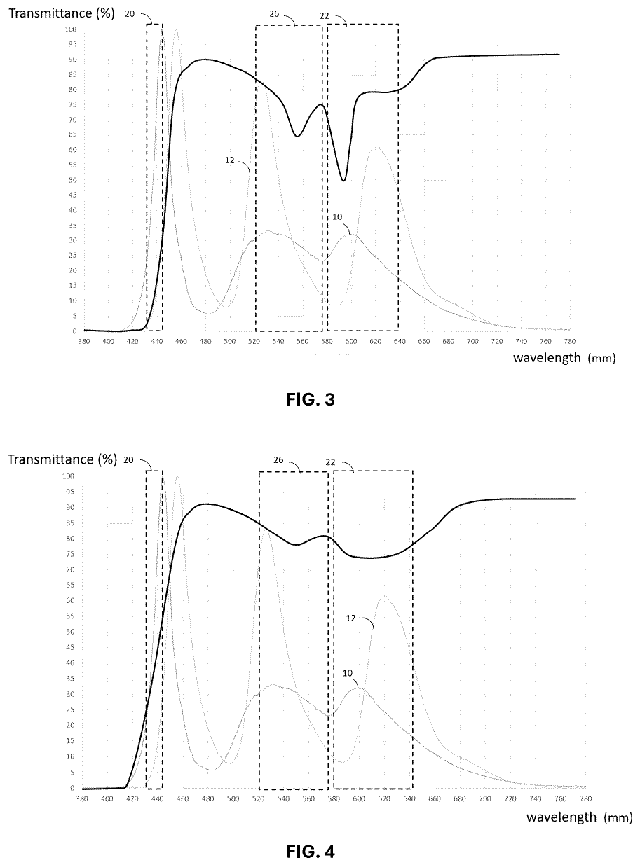

With reference to FIG. 3, another embodiment of the optical filter is illustrated through a spectral diagram. This embodiment differs from the profile shown in FIG. 2 primarily in the absorption characteristics of the second light-absorbing dye. In this embodiment, the second light-absorbing dye exhibits an average absorption rate exceeding 30% and demonstrates a distinctive dual-region absorption profile comprising a peak-valley section and a flat section. The peak-valley section, spanning 580 nm to 600 nm, features a center wavelength with a full width at half maximum ranging from 10 nm to 20 nm. This region corresponds to the LCD orange-red light emission peak 22, with maximum absorption occurring between 590 nm to 595 nm at rates exceeding 40%. The flat section extends from 600 nm to 640 nm, aligning with the OLED orange-red light emission peak 22, and maintains absorption rates greater than 20%. The width of the flat section may be in a range of 30 nm to 60 nm.

In this context, the “flat section” is defined as the portion in which the difference between the maximum and minimum absorption values remains within plus or minus 5%.

The experimental results for this embodiment, as shown in FIG. 3, demonstrate optimal performance characteristics. The first light-absorbing dye achieves an absorption rate exceeding 80% within the blue light wavelength region near 435 nm. The second light-absorbing dye shows peak absorption between 590 nm to 595 nm, attenuating approximately 40%-50% of incident orange-red light in wavelength range 22 (corresponding to a minimum transmittance valley of approximately 60%-50%), the width of the flat section may be in a range of 30 nm to 60 nm. The third light-absorbing dye demonstrates maximum absorption at 550 nm within the 520 nm to 580 nm range, absorbing approximately 35% of green light in wavelength range 26 (corresponding to a minimum transmittance valley of approximately 65%). This synergistic combination effectively mitigates blue light hazards while preserving high optical clarity with overall transmittance exceeding 80% and maintaining white balance characteristics that closely approximate natural color rendering.

With reference to FIG. 4, yet another embodiment of the optical filter is presented through spectrum. In this embodiment, the first light-absorbing dye demonstrates absorption rates of at least 50% for blue light within wavelength range 20 (435 nm to 440 nm), corresponding to transmittance values of approximately 35% to 50%. While maintaining color temperature deviation within 500K, the second light-absorbing dye shows high absorption efficiency, attenuating greater than 20% of orange-red light in wavelength range 22 (580 nm to 640 nm), which correlates to transmittance below 80%. The third light-absorbing dye provides moderate absorption of 20% to 25% for green light within wavelength range 26 (520 nm to 580 nm), corresponding to transmittance values of 75% to 80%.

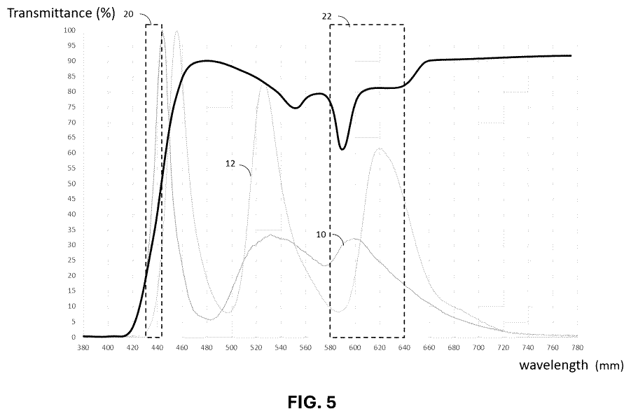

With reference to FIG. 5, still another embodiment of the optical filter is illustrated. This variant maintains similar blue light absorption characteristics, with the first light-absorbing dye absorbing greater than 50% of blue light in wavelength range 20 (435 nm to 440 nm), equivalent to approximately 35% to 50% transmittance. Color temperature stability is preserved within 500K deviation through the second light-absorbing dye, which shows an average absorption rate exceeding 20% and features a bimodal absorption profile. The absorption spectrum comprises a peak-valley section spanning 580 nm to 600 nm with a center wavelength exhibiting a full width at half maximum of 10 nm to 20 nm. This region targets the LCD emission characteristics, with peak absorption between 590 nm to 595 nm exceeding 30%, corresponding to orange-red light region 22. The flat section extends from 600 nm to 640 nm, specifically addressing OLED emission characteristics in orange-red light region 22, with absorption rates greater than 10%, the width of the flat section may be in a range of 30 nm to 60 nm.

Accordingly, the optical filter and associated optical protector described herein provide comprehensive blue light mitigation through systematic spectral engineering. The optimal absorption characteristics of the first light-absorbing dye within the 430 nm to 460 nm range are determined based on disclosure-specific transmittance requirements. Color temperature compensation is achieved through strategic absorption of orange-red light (580 nm to 640 nm) within acceptable deviation limits of 350K to 500K. By maintaining second light-absorbing dye absorption rates above 15% in the specified wavelength range, the optical filter achieves dual functionality: effective blue light hazard reduction and preserved display quality. This design approach enables universal compatibility across LED and OLED backlight technologies, providing versatile solutions for diverse display disclosures.

What is claim is

1. An optical filter comprising a light absorption layer formed on a transparent substrate by mixing multiple dyes, and the light absorption layer comprising:
a first light-absorbing dye for absorbing blue light between 435 nm and 460 nm; and
a second light-absorbing dye for absorbing orange-red light between 580 nm and 640 nm with an average absorption rate greater than 15%.

2. The optical filter according to claim 1, wherein the second light-absorbing dye has an average absorption rate greater than 15% and includes an absorption flat section with a width between 30 and 60 nm.

3. The optical filter according to claim 1, wherein the second light-absorbing dye has a maximum absorption rate greater than 25% and includes an absorption flat section with a width between 30 and 60 nm.

4. The optical filter according to claim 1, wherein the absorption waveform of the second light-absorbing dye between 580 nm and 640 nm has a peak-valley section and a flat section, the peak-valley section having a center wavelength between 580 and 600 nm, and the flat section being between 600 and 640 nm.

5. The optical filter according to claim 4, wherein
the peak-valley section has an absorption peak between 590 nm and 595 nm with an absorption rate greater than 40%; and
the flat section is between 600 nm and 640 nm with an absorption rate greater than 20%.

6. The optical filter according to claim 4, wherein:
the peak-valley section has an absorption peak between 590 nm and 595 nm with an absorption rate greater than 30%; and
the flat section is between 600 nm and 640 nm with an absorption rate greater than 10%.

7. The optical filter according to claim 1, further comprising a third light-absorbing dye for absorbing greater than 10% of green light between 520 nm and 580 nm.

8. The optical filter according to claim 1, wherein the first light-absorbing dye absorbs greater than or equal to 50% of blue light in the wavelength range from 435 nm to 440 nm.

9. The optical filter according to claim 1, wherein the first light-absorbing dye absorbs 30% to 50% of blue light between 435 nm and 440 nm, and absorbs greater than 10% of blue light in the wavelength range from 450 nm to 460 nm.

10. The optical filter according to claim 1, wherein the first light-absorbing dye further absorbs greater than 90% of violet-blue light in the wavelength range from 380 nm to 410 nm.
